(19) United States
(12) Patent Application Publication
(10) Pub. No.: US 2015/0209869 A1
(43) Pub. Date: Jul. 30, 2015

(54) MACHINE TOOL

(71) Applicant: MITSUBISHI HEAVY INDUSTRIES, LTD., Minato-ku, Tokyo (JP)

(72) Inventor: Takayuki Kume, Tokyo (JP)

(73) Assignee: MITSUBISHI HEAVY INDUSTRIES, LTD., Minato-ku, Tokyo (JP)

(21) Appl. No.: 14/422,627

(22) PCT Filed: Jun. 20, 2013
(86) PCT No.: PCT/JP2013/066917

§ 371 Date: Feb. 19, 2015

(30) Foreign Application Priority Data
Aug. 30, 2012 (JP) 2012-189439

(51) Int. Cl. B23B 31/107; B23B 31/30

(52) U.S. Cl. CPC B23B 31/1071; B23B 31/30; B23B 2231/04; B23B 2270/025; B23B 2270/08

(57) ABSTRACT

A machine tool, on which a tool unit is attached to a main shaft via an attachment, wherein: the attachment has a cylinder fixed to the main shaft and a piston slidably held on the cylinder; the cylinder has a plurality of spherical bodies capable of projecting in the radial direction of the cylinder; the piston has an abutment face that causes the spherical bodies to project in the radial direction of the cylinder when the piston slides toward one side with respect to the cylinder; and the tool unit has a projection inclined face projecting in the radial direction of the tool unit, and is coupled to the attachment by way of the projection inclined face being in pressing contact with the spherical bodies that were caused to project by the piston sliding toward the one side.

### TECHNICAL FIELD

The present invention relates to a machine tool.

### BACKGROUND ART

In a machine tool, machining is performed on a workpiece by using a program and the like, and tools used for machining are replaced as appropriate depending on machined portions, machining steps, and the like. Patent Document 1 and Patent Document 2 can be given as examples of techniques related to tool replacement in a machine tool.

Patent Document 1 shows a tool replacement device as follows. A clamping device configured to clamp a tool has an inner peripheral face of a holding hole into which the tool is inserted and by which an outer periphery of the tool is held, and a wedge member is disposed to fit between the inner peripheral face of the holding hole in the clamping device and an outer peripheral face of the tool by rotation of the tool. This tool replacement device can automatically replace tools which are suitable for high speed rotation and which have smooth outer peripheral faces without key grooves or the like. Specifically, a device configured to mainly automatically replace tools which have good rotational balance and which are detachably attached to a main spindle of a high-speed machine can be made suitable for high-speed rotation and have simple and compact structure.

Patent Document 2 is a technique related to a control device for a device configured to easily perform coupling between a draw bar and a tool, and shows a tool attachment-detachment rotation control device which controls a rotation drive unit configured to screw-couple the tool to the fixed draw bar by rotating a tool holding portion holding the tool. In this technique, since the rotation drive unit screw-couples the tool to the fixed draw bar by rotating the tool relative to the draw bar and the tool attachment-detachment rotation control device appropriately controls the rotation drive unit, coupling between the draw bar and the tool is very easy.

### PRIOR ART DOCUMENT

### Patent Document

Patent Document 1: Japanese Patent Application Publication No. Hei 10-080836
Patent Document 2: Japanese Patent Application Publication No. 2001-047336

### SUMMARY OF THE INVENTION

### Problems to be Solved by the Invention

However, in the clamping of the tool in Patent Document 1 and Patent Document 2, screw portions are provided on the tool side and the main spindle side, and the screw portions are screw-coupled to each other. Accordingly, the diameters and the lengths of the screws cannot be reduced in view of securing coupling force between the tool side and the main spindle side. In other words, it is difficult to reduce the sizes of portions around the tool and the main spindle. Moreover, although the automatic replacement of tools is achieved, time is required for attaching and detaching of screw coupling because the tools and the like are rotated. Accordingly, it is difficult to improve the operating ratio of the machine tool.

Moreover, in a machine tool capable of machining narrow and small portions, automatic machining is performed by using a program while replacement of tools used for machining is manually performed by an operator. This is because limitations are imposed on the sizes of portions and parts of the machine tool for machining narrow and small portions to enable machining of narrow and small portions. In other words, in the machine tool capable of machining narrow and small portions, the size of a mechanism for tool replacement particularly needs to be reduced. However, even if the size of the mechanism for tool replacement in the conventional machine tool is simply reduced, the mechanism cannot be employed in the machine tool for machining narrow and small portions.

The present invention has been made in view of the problems described above, and an object thereof is to simplify a mechanism for tool replacement in a machine tool and reduce the sizes of portions around a tool and a main spindle.

### Means for Solving the Problems

A machine tool of a first aspect of the invention for solving the problems described above is a machine tool in which a tool unit having a tool used for machining is attached to a main spindle via an attachment, characterized in that the attachment has a cylinder portion fixed to the main spindle and a piston portion slidably held by the cylinder portion, the cylinder portion has a plurality of spherical bodies capable of projecting in a radial direction of the cylinder portion, the piston portion has an abutment face configured to cause the spherical bodies to project in the radial direction of the cylinder portion when the piston portion slides to one side relative to the cylinder portion, and the tool unit has a projection inclined face projecting in a radial direction of the tool unit and is coupled to the attachment by the projection inclined face being pressed against the spherical bodies caused to project in the radial direction of the cylinder portion by the sliding of the piston portion to the one side.

A machine tool of a second aspect of the invention for solving the problems described above is characterized in that the piston portion has an escape hole which allows the steel ball to move in the radial direction of the cylinder portion and which is located at a position corresponding to each of the steel balls when the piston slides to another side, the escape hole, and in the tool unit, when the piston portion slides to the other side relative to the cylinder portion, the escape hole is set at the position corresponding to the steel ball and the spherical body is set to become movable in the radial direction of the cylinder portion, the tool unit thereby being released from the spherical body and set to become detachable from the attachment.

A machine tool of a third aspect of the invention for solving the problems described above is characterized in that the attachment has: an elastic body which is provided such that force causing the piston portion to slide to the one side acts on the piston portion; and a fluid supply space to which fluid is supplied such that force causing the piston portion to slide to the other side acts on the piston portion, and the piston portion slides to the other side by pressure of the fluid when the fluid is supplied to the fluid supply space, and slides to the one side due to elastic deformation of the elastic body when the fluid is discharged from the fluid supply space.

A machine tool of a fourth aspect of the invention for solving the problems described above is characterized in that the machine tool comprises a tool unit holding device configured to assist in attaching and detaching of the tool unit and transport the tool unit.

### Effect of the Invention

According to the machine tool of the first aspect of the invention, since the tool unit is coupled to the attachment by pressing the spherical bodies of the cylinder portion against the projection inclined face of the tool unit by the sliding of the piston portion toward the one side, the tool unit and the attachment can be coupled to each other with predetermined coupling force in a simple mechanism. Furthermore, since no screw coupling is employed, the lengths and screw diameters of screw coupling portions for obtaining predetermined coupling force are unnecessary. Accordingly, the sizes of the tool unit and attachment can be reduced. Moreover, since the tool unit and the attachment can be attached to each other only by causing the piston portion to slide to the one side relative to the cylinder portion, work of rotating a member such as screw coupling is not involved, and the attachment time can be reduced.

According to the machine tool of the second aspect of the invention, since the tool unit is set to become detachable from the attachment only by causing the piston portion to slide to the other side relative to the cylinder portion, it is possible to release the tool unit from the predetermined coupling force and detach the tool unit from the attachment in a simple mechanism. Moreover, since the detachment of the tool unit and the attachment can be performed only by causing the piston portion to slide to the other side relative to the cylinder portion, work of rotating a member such as screw coupling is not involved, and the detachment time can be reduced.

According to the machine tool of the third aspect of the invention, since the piston portion can be caused to slide to the one side and the other side by supplying and discharging the fluid to and from the fluid supply space, the mechanism for attaching and detaching the tool unit and the attachment can have a simple structure, and the attaching and detaching of the tool unit to and from the attachment can be facilitated.

According to the machine tool of the fourth aspect of the invention, since the attaching and detaching of the tool unit to and from the attachment can be automatically performed by causing the tool unit holding device to transport the tool unit and assist in the attaching and detaching of the tool unit to and from the attachment, the tool can be automatically replaced.

### BRIEF DESCRIPTION OF THE DRAWINGS

FIG. 1 is a vertical cross-sectional view showing portions around a tool in a machine tool of Embodiment 1.

FIG. 2 is a perspective view showing the machine tool of Embodiment 1.

FIG. 3 is an explanatory view showing a clamp mechanism of a tool in the machine tool of Embodiment 1.

FIG. 4 is an explanatory view showing the clamp mechanism of the tool in the machine tool of Embodiment 1.

FIG. 5 is an explanatory view showing the clamp mechanism of the tool in the machine tool of Embodiment 1.

FIG. 6 is an explanatory view showing the clamp mechanism of the tool in the machine tool of Embodiment 1.

FIG. 7 is an explanatory view showing tool replacement in the machine tool of Embodiment 1.

FIG. 8 is a front view showing a tool unit holding device in the machine tool of Embodiment 1.

### MODE FOR CARRYING OUT THE INVENTION

An embodiment of a machine tool in the present invention is described below in detail with reference to the attached drawings. As a matter of course, the present invention is not limited to the embodiment described below, and various modifications can be made within a scope not departing from the spirit of the present invention.

### Embodiment 1

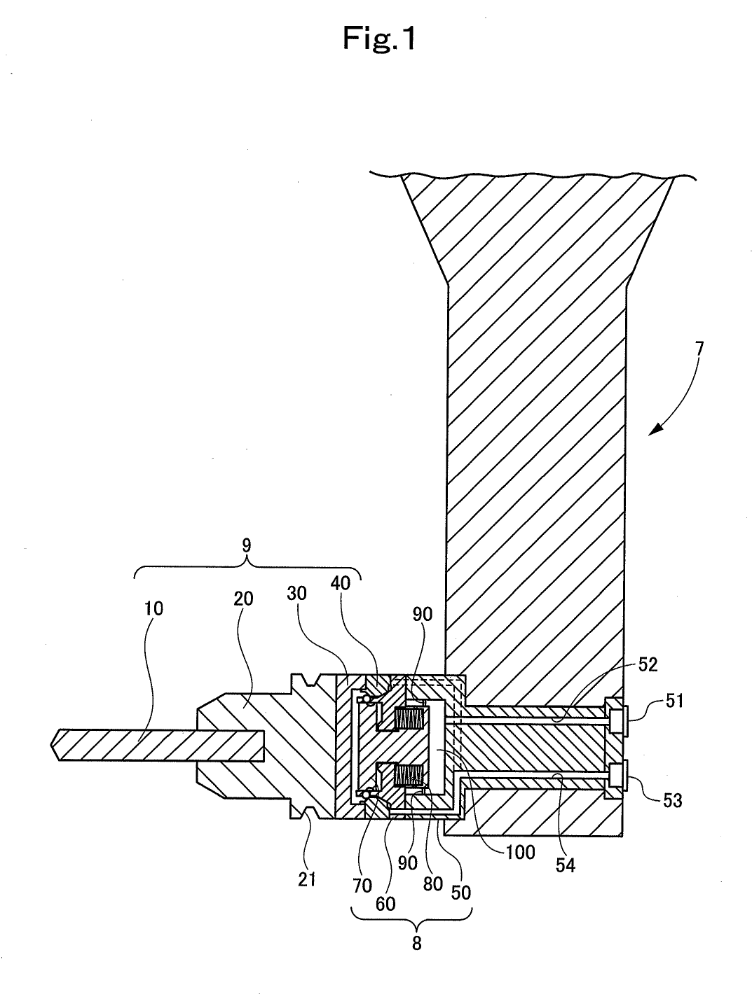

First, the machine tool of the present invention described with reference to FIGS. 1 to 8.

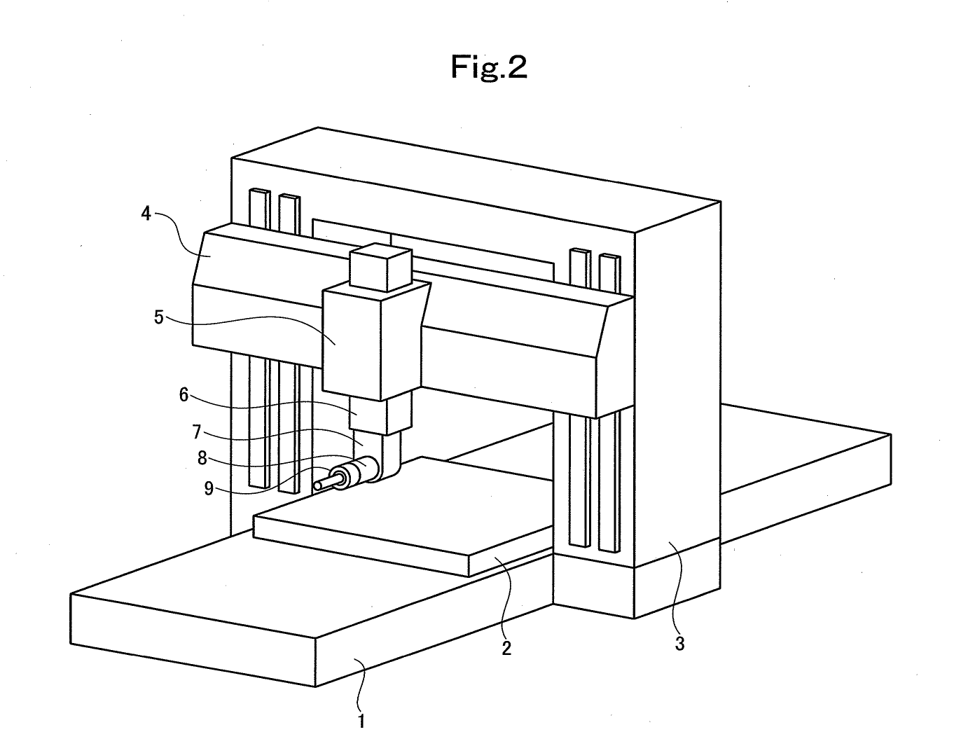

The machine tool of the embodiment is a double-column machining center capable of machining narrow and small portions. As shown in FIG. 2, the machine tool includes a bed 1, a table 2, a column 3, a cross rail 4, a saddle 5, a ram 6, a main spindle 7 included in the ram 6, and a tool unit 9 attached to the main spindle 7 via an attachment 8.

The bed 1 is horizontally installed under a floor, and the table 2 and the column 3 are installed on the bed 1. The table 2 is a stage on which a not-illustrated workpiece is placed and can move in one direction on the bed 1. The cross rail 4 is installed on the vertically-installed gate-shaped column 3 and can move in a direction perpendicular to the column 3. The saddle 5 is installed on the cross rail 4 and can rotate and move in an axial direction relative to the cross rail 4 to change a position and direction of machining the workpiece. The ram 6 is held by the saddle 5 and can slide in an axial direction relative to the saddle 5. The main spindle 7 is held by the ram 6 and can be rotated by a not-illustrated drive device.

The tool unit 9 is a unit which enables a tool 10 to be attached to and detached from the attachment 8. As shown in FIG. 1, the tool unit 9 includes the tool 10, a tool holder 20 configured to hold the tool 10, and a tool clamping member 40 attached to the tool holder 20 via a spacer 30. The tool unit 9 is coupled to the attachment 8 in the tool clamping member 40. A recess groove 21 is provided in the tool holder 20 to facilitate attaching and detaching of the tool unit 9 to and from the attachment 8 (details will be described later).

The attachment 8 is used to attach the tool unit 9 to the main spindle 7. As shown in FIG. 1, the attachment 8 includes a cylinder 50 fixed to the main spindle 7, a cylinder head 60 fixed to the cylinder 50, and a piston 70 slidably supported by the cylinder 50 and the cylinder head 60. In the embodiment, since a disc spring 80 is installed between the cylinder head 60 and the piston 70, predetermined force generated by elastic deformation of the disc spring 80 always acts on the piston 70. In other words, the piston 70 is always in a load state of being moved toward one side (right side in FIG. 1) in an axial direction where the cylinder 50 is installed.

As a matter of course, the force acting on the piston 70 is not limited to the force generated by elastic deformation of the disc spring 80 in the embodiment. For example, an elastic body such as urethane rubber or the like may be installed to cause force generated by elastic deformation of the urethane rubber or the like to act on the piston 70. Alternatively, a configuration may be employed in which a closed space is formed between the cylinder head 60 and the piston 70 and fluid such as hydraulic oil or the like is poured into the space to cause hydraulic pressure or the like to act on the piston 70. Moreover, a configuration may be employed in which a coil spring or the like is installed on one side of the piston 70 where the cylinder 50 is installed, and the piston 70 is pulled to the one side due to elastic deformation of the coil spring or the like.

Moreover, a pressure oil chamber 100 which is a closed space is formed by installing a sealing member 90 between the cylinder 50 and the piston 70. Hydraulic pressure is caused to act on the piston 70 by supplying hydraulic pressure oil from an oil feed port 51 formed in the cylinder 50 to the pressure oil chamber 100 via an oil feed passage 52.

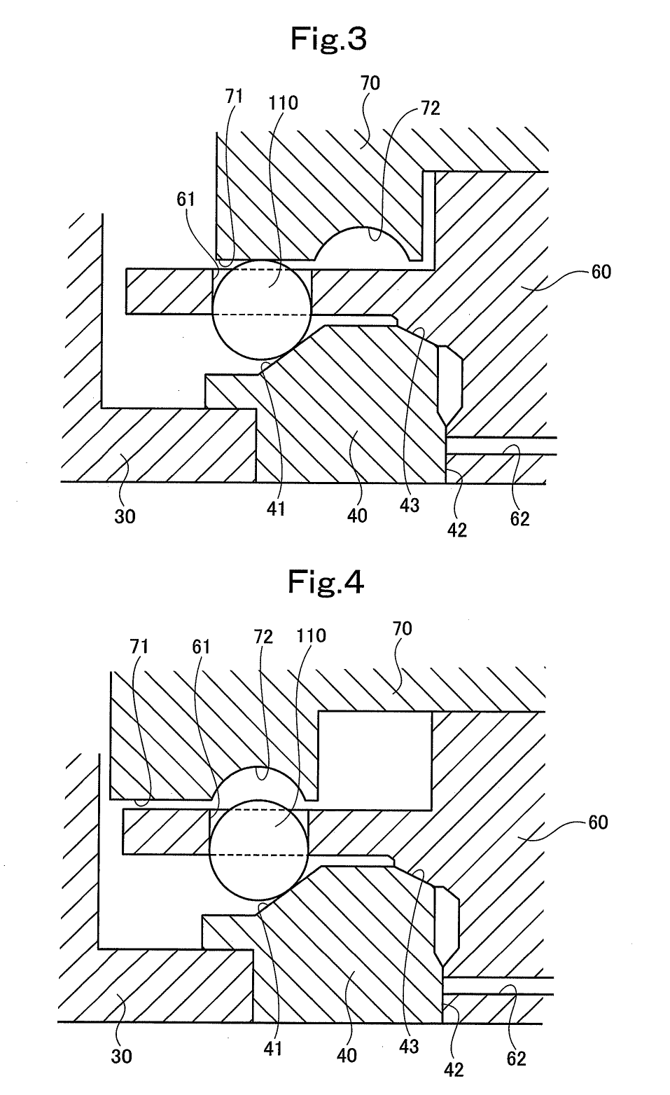

Furthermore, an air feed port 53 is formed in the cylinder 50. Supplying air from the air feed port 53 in the attaching and detaching of the attachment 8 and the tool unit 9 can cause air to flow through an air feed passage 54 formed in the cylinder 50 and an air hole 62 (see FIGS. 3 to 6) formed in the cylinder head 60 and blow away dusts and the like between the cylinder head 60 in the attachment 8 and the tool clamping member 40 in the tool unit 9 configured to come into close contact with each other.

As shown in FIGS. 3 and 6, a circular hole 61 is provided in the cylinder head 60, and a steel ball 110 is provided in the circular hole 61. Multiple circular holes 61 are provided along a circumference of the cylinder head 60, and the steel ball 110 is provided in each of the circular holes 61 in such a way as not to fall out from the circular hole 61. The steel ball 110 is held to be slightly movable only in a radial direction of the cylinder head 60, and is held to be immovable in an axial direction and a circumferential direction of the cylinder head 60.

The piston 70 has an abutment face 71 for applying load on the steel ball 110 by abutting on the steel ball 110 and an escape hole 72 allowing movement of the steel ball 110 in the radial direction of the cylinder head 60. The escape hole 72 is at a position corresponding to the steel ball 110 when the piston 70 slides to the other side in the axial direction where the tool unit 9 is attached.

In a state where the tool unit 9 is attached to the main spindle 7 via the attachment 8, as shown in FIG. 3, the steel ball 110 held in the circular hole 61 of the cylinder head 60 is in contact with the abutment face 71 of the piston 70 and a projection inclined face 41 obliquely projecting in a radial direction of the tool clamping member 40. In other words, the steel ball 110 is in a state pressed against the projection inclined face 41 of the tool clamping member 40 by the abutment face 71 of the piston 70 and the circular hole 61 of the cylinder head 60. Accordingly, the tool unit 9 including the tool clamping member 40 is not detached from the attachment 8 including the steel ball 110.

Moreover, multiple contact portions between the attachment 8 and the tool unit 9 are provided to stabilize coupling between the attachment 8 and the tool unit 9. Specifically, the cylinder head 60 in the attachment 8 and the tool clamping member 40 in the tool unit 9 are in contact with the each other via the steel ball 110 and are also in direct contact with each other at a right-angle contact face 42 and an inclined contact face 43 of the tool clamping member 40.

The attachment angle of the tool unit 9 with respect to the attachment 8 can be accurately and easily determined by bringing the right-angle contact face 42 of the tool clamping member 40 into contact with the cylinder head 60. Moreover, it is possible to improve the stiffness in the axial direction of the tool 10 in the machining of the not-illustrated workpiece by the tool 10.

The attachment angle of the tool unit 9 with respect to the attachment 8 can be more accurately and easily determined by brining the inclined contact face 43 of the tool clamping member 40 into contact with the cylinder head 60. Moreover, it is possible to improve the stiffness not only in the axial direction of the tool 10 but also in the radial direction of the tool 10 in the machining of the not-illustrated workpiece by tool 10.

Note that, in the attaching and detaching of the attachment 8 and the tool unit 9, since dust and the like near the right-angle contact face 42 and the inclined contact face 43 are blown away by spraying air from the air hole 62 provided in the cylinder head 60, no dust or the like is caught on the right-angle contact face 42 and the inclined contact face 43. Accordingly, coupling of the attachment 8 and the tool unit 9 can be further stabilized.

As a matter of course, the structures of the attachment 8 and the tool unit 9 are not limited to those in the embodiment. For example, the abutment face 71 of the piston 70 may be formed as an inclined face (inclined face in which the abutment face 71 extends downward toward the left in FIG. 3) projecting in a radial direction such that the projection amount becomes greater toward the tool unit 9. Forming the abutment face 71 of the piston 70 as the inclined face can cause the pressing force by which the abutment face 71 of the piston 70 presses the steel ball 110 against the projection inclined face 41 of the tool clamping member 40 to increase as the piston 70 is moved by the force of elastic deformation of the disc spring 80 toward the one side (right side in FIG. 3) in the axial direction where the cylinder 50 is installed. Accordingly, coupling force between the tool unit 9 and the attachment 8 can be increased. Moreover, the pressing force by which the abutment face 71 of the piston 70 presses the steel ball 110 against the projection inclined face 41 of the tool clamping member 40 can be increased also by changing the type and the like of the disc spring 80 installed between the cylinder head 60 and the piston 70.

In the attaching and detaching of the attachment 8 and the tool unit 9, the hydraulic oil is introduced into the pressure oil chamber 100 provided between the cylinder 50 and the piston 70 to apply hydraulic pressure on the piston 70, the hydraulic pressure being greater than the force generated by elastic deformation of the disc spring 80. The piston 70 is caused to slide by the hydraulic pressure toward the other side in the axial direction where the tool unit 9 is attached, and the escape hole 72 provided in the abutment face 71 of the piston 70 is set at the position corresponding to the steel ball 110 (see FIG. 4).

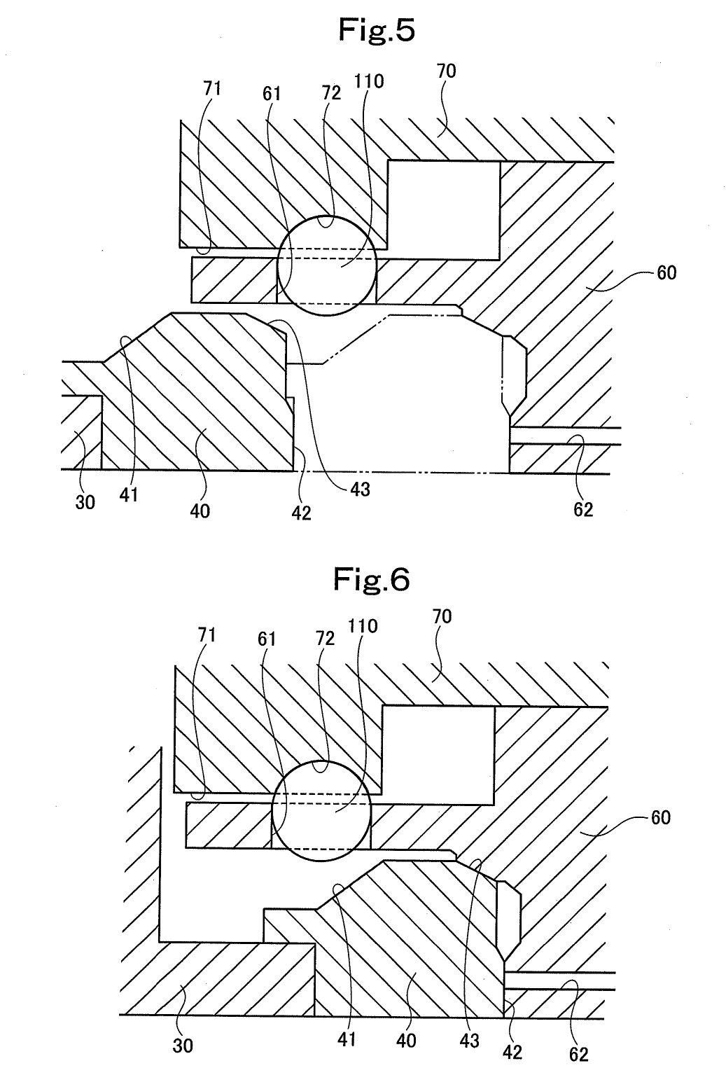

In a case of detaching the tool unit 9 from the attachment 8, moving the tool unit 9 to the opposite side to the attachment 8 can cause the projection inclined face 41 of the tool clamping member 40 to push away the steel ball 110 provided in the circular hole 61 of the cylinder head 60 in the attachment 8. Part of the steel ball 110 is thereby fitted into the escape hole 72 of the piston 70, and the tool unit 9 can be detached from the attachment 8 (see FIG. 5).

In a case of attaching the tool unit 9 to the attachment 8, moving the tool unit 9 toward the attachment 8 can cause the inclined contact face 43 of the tool clamping member 40 to push away the steel ball 110 provided in the circular hole 61 of the cylinder head 60 in the attachment 8. Part of the steel ball 110 is thereby fitted into the escape hole 72 of the piston 70, and the tool unit 9 can be attached to the attachment 8 (see FIG. 6).

In the machine tool of the embodiment, the attaching and detaching of the attachment 8 and the tool unit 9 is performed by using an unclamping device 120 and a tool unit holding device 130.

The unclamping device 120 is a device configured to supply hydraulic oil and air required in the detaching of the tool unit 9 from the attachment 8. The unclamping device 120 includes an oil feed port 121 configured to supply the hydraulic oil by being connected to the oil feed port 51 of the cylinder 50, an air feed port 122 configured to supply air by being connected to the air feed port 53 of the cylinder 50, and a wheeled platform 123 used for moving.

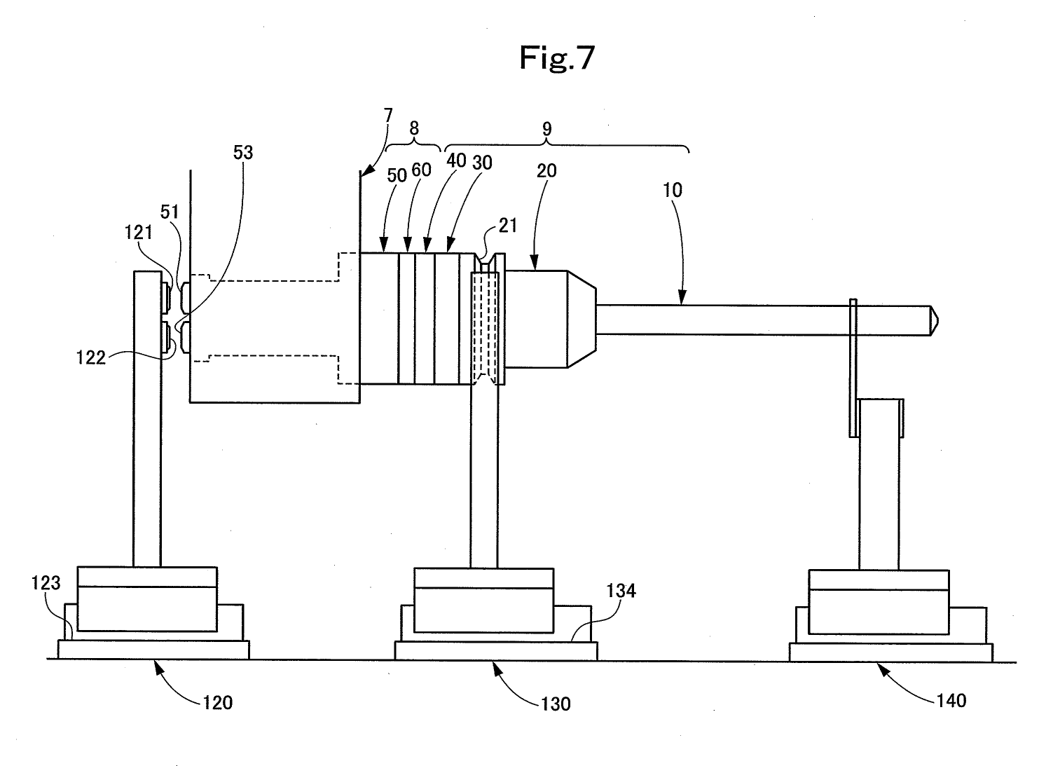

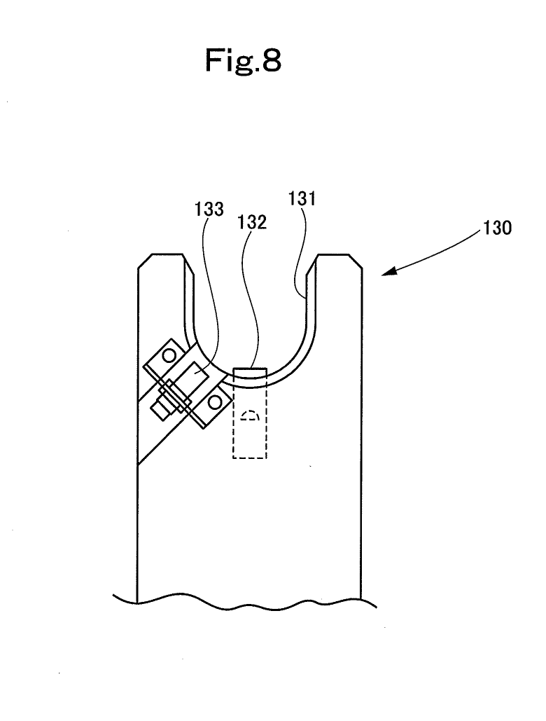

The tool unit holding device 130 is a device configured to support and hold the tool unit 9 detached from the attachment 8. As shown in FIGS. 7 and 8, the tool unit holding device 130 includes an U-shaped claw portion 131 configured to be fitted to the recess groove 21 of the tool holder 20, a key 132 used for aligning of a phase in the holding of the tool unit 9, a proximity sensor 133 configured to check whether the tool unit 9 is held, and a wheeled platform 134 used for moving. Note that a tool supporting device 140 configured to support part of the tool 10 in the tool unit 9 is preferably provided to stabilize the holding of the tool unit 9.

Next, automatic replacement of the tool in the machine tool of the embodiment is described with reference to FIGS. 1 to 7.

In the machine tool of the embodiment, a not-illustrated tool replacement space for replacement of the tool unit 9 is provided in a movable area of the attachment 8, and the replacement (attaching and detaching) of the tool unit 9 is performed by moving the attachment 8 to a tool replacement position in the tool replacement space.

First, as shown in FIG. 7, the unclamping device 120 and the tool unit holding device 130 are brought close to the main spindle 7 located at the tool replacement position in the tool replacement space, and the tool unit 9 is set to become detachable from the attachment 8 by causing the unclamping device 120 to feed oil and air.

The oil feed port 121 of the unclamping device 120 brought close to the attachment 8 is connected to the oil feed port 51 of the cylinder 50 in the attachment 8, and the air feed port 122 of the unclamping device 120 is connected to the air feed port 53 of the cylinder 50 in the attachment 8.

When the hydraulic oil is supplied from the unclamping device 120 to the pressure oil chamber 100 in the attachment 8, hydraulic pressure is generated. This hydraulic pressure is transmitted to the piston 70 in the attachment 8 as pressing force, and the hydraulic oil is supplied to the pressure oil chamber 100 until the hydraulic pressure exceeds the force generated by elastic deformation of the disc spring 80. Specifically, pressure stronger than the force generated by elastic deformation of the disc spring 80 acts on the piston 70 due to the hydraulic pressure of the hydraulic oil supplied from the unclamping device 120, and the piston 70 is moved along the cylinder 50 and the cylinder head 60 to the other side where the tool unit 9 is attached.

As shown in FIG. 4, the movement of the piston 70 relative to the cylinder 50 and the cylinder head 60 causes the escape hole 72 of the piston 70 to be set at the position corresponding to the steel ball 110 provided in the circular hole 61 of the cylinder head 60.

Next, the tool unit 9 is detached from the attachment 8 by the tool unit holding device 130.

When the tool unit holding device 130 is moved in a direction away from the attachment 8, the tool unit 9 can be detached from the attachment 8 because the U-shaped claw portion 41 of the tool unit holding device 130 is caught in the recess groove 21 of the tool holder 20 in the tool unit 9.

At this time, the projection inclined face 41 of the tool clamping member 40 pushes away the steel ball 110 provided in the circular hole 61 of the cylinder head 60 in the attachment 8, and the steel ball 110 is thereby fitted into the escape hole 72 of the piston 70 (see FIG. 5). Accordingly, there is nothing (steel ball 110) pressing the tool unit 9 against the attachment 8, and the tool unit 9 can be detached.

Next, the tool unit 9 detached from the attachment 8 and the tool unit holding device 130 are moved to a not-illustrated retreat space, and the new tool unit 9 and tool unit holding device 130 are brought close to the attachment 8 located at the tool replacement position in the tool replacement space.

One tool unit 9 and one tool unit holding device 130 correspond to one tool 10. Specifically, the machine tool includes various tools 10 adapting to various types of machining, various tool units 9 to which the various tools 10 are attached, and various tool unit holding devices 130 holding the various tool units 9. These various tool units 9 and tool unit holding devices 130 are arranged in the not-illustrated retreat space.

Next, the new tool unit 9 held by the new tool unit holding device 130 is attached to the attachment 8.

The tool unit holding device 130 is moved in a direction approaching the attachment 8. Since the steel ball 110 provided in the circular hole 61 of the cylinder head 60 is in a state fitted into the escape hole 72 of the piston 70 (see FIG. 5), the tool unit 9 can be moved to the attaching position in the attachment 8 (see FIG. 6).

At this time, air is supplied from the unclamping device 120. The supplied air is sprayed from the air hole 62 and blown on the right-angle contact face 42 and the inclined contact face 43 of the tool clamping member 40 in the tool unit 9. The right-angle contact face 42 and the inclined contact face 43 of the tool clamping member 40 can be thereby cleaned with air. Since the tool clamping member 40 and the cylinder head 60 are closely attached to each other with no dust or the like interposed therebetween, the degree of close attachment between the tool unit 9 and the attachment 8 is improved. Moreover, the tool unit 9 and the attachment 8 can be attached to each other in an accurate attachment direction.

Next, the feeding of oil by the unclamping device 120 is stopped, and the hydraulic oil in the pressure oil chamber 100 in the attachment 8 is discharged. Absence of hydraulic oil in the pressure oil chamber results in no hydraulic pressure acting on the piston 70. Accordingly, only the force generated by elastic deformation of the disc spring 80 acts on the piston 70, and the piston 70 is moved to the one side where the cylinder 50 is installed (see FIG. 3).

Moving the piston 70 relative to the cylinder 50 causes the escape hole 72 to be set at a position not corresponding to the steel ball 110 provided in the circular hole 61 of the cylinder head 60. Specifically, the steel ball 110 pushed out from the escape hole 72 of the piston 70 is supported by the abutment face 71 of the piston 70 and pushed against the projection inclined face 41 of the tool clamping member 40 in the tool unit 9. The tool unit 9 is thereby pushed toward the attachment 8 by the steel ball 110, and the attaching of the tool unit 9 to the attachment 8 is completed.

### INDUSTRIAL APPLICABILITY

In the present invention, it is possible to reduce the sizes of the tool unit and the attachment and perform automatic replacement of the tools. Accordingly, the present invention is suitable as a machine tool, particularly as a machine tool for machining narrow and small portions.

### EXPLANATIONS OF REFERENCE NUMERALS

1 BED
2 TABLE
3 COLUMN
4 CROSS RAIL
5 SADDLE
6 RAM
7 MAIN SPINDLE
8 ATTACHMENT
9 TOOL UNIT
10 TOOL
20 TOOL HOLDER
21 RECESS GROOVE OF TOOL HOLDER
30 SPACER
40 TOOL CLAMPING MEMBER
41 PROJECTION INCLINED FACE OF TOOL CLAMPING MEMBER
42 RIGHT-ANGLE CONTACT FACE OF TOOL CLAMPING MEMBER
43 INCLINED CONTACT FACE OF TOOL CLAMPING MEMBER
50 CYLINDER
51 OIL FEED PORT OF CYLINDER
52 OIL FEED PASSAGE OF CYLINDER
53 AIR FEED PORT OF CYLINDER
54 AIR FEED PASSAGE OF CYLINDER
60 CYLINDER HEAD
61 CIRCULAR HOLE OF CYLINDER HEAD
62 AIR HOLE OF CYLINDER HEAD
70 PISTON
71 ABUTMENT FACE OF PISTON
72 ESCAPE HOLE OF PISTON
80 DISC SPRING
90 SEALING MEMBER
100 PRESSURE OIL CHAMBER
110 STEEL BALL
120 UNCLAMPING DEVICE
130 TOOL UNIT HOLDING DEVICE
140 TOOL SUPPORTING DEVICE

1. A machine tool in which a tool unit having a tool used for machining is attached to a main spindle via an attachment, characterized in that
the attachment has a cylinder portion fixed to the main spindle and a piston portion slidably held by the cylinder portion,
the cylinder portion has a plurality of spherical bodies capable of projecting in a radial direction of the cylinder portion,
the piston portion has an abutment face configured to cause the spherical bodies to project in the radial direction of the cylinder portion when the piston portion slides to one side relative to the cylinder portion, and
the tool unit has a projection inclined face projecting in a radial direction of the tool unit and is coupled to the attachment by the projection inclined face being pressed against the spherical bodies caused to project in the radial direction of the cylinder portion by the sliding of the piston portion to the one side.

2. The machine tool according to claim 1, characterized in that
the piston portion has an escape hole which allows the spherical body to move in the radial direction of the cylinder portion and which is located at a position corresponding to each of the steel balls when the piston portion slides to another side, and
in the tool unit, when the piston portion slides to the other side relative to the cylinder portion, the escape hole is set at the position corresponding to the spherical body and the spherical body is set to become movable in the radial direction of the cylinder portion, the tool unit thereby being released from the spherical body and set to become detachable from the attachment.

3. The machine tool according to claim 2, characterized in that
the attachment has: an elastic body which is provided such that force causing the piston portion to slide to the one side acts on the piston portion; and a fluid supply space to which fluid is supplied such that force causing the piston portion to slide to the other side acts on the piston portion, and
the piston portion slides to the other side by pressure of the fluid when the fluid is supplied to the fluid supply space, and slides to the one side due to elastic deformation of the elastic body when the fluid is discharged from the fluid supply space.

4. The machine tool according to claim 2, characterized in that the machine tool further comprises a tool unit holding device configured to assist in attaching and detaching of the tool unit and transport the tool unit.

5. The machine tool according to claim 3, characterized in that the machine tool further comprises a tool unit holding device configured to assist in attaching and detaching of the tool unit and transport the tool unit.
